(19) United States
(12) Patent Application Publication
(10) Pub. No.: US 2014/0199959 A1
(43) Pub. Date: Jul. 17, 2014

(54) LOCATION DETERMINATION FOR EMERGENCY SERVICES IN WIRELESS NETWORKS

(71) Applicant: MICROSOFT CORPORATION, Redmond, WA (US)

(72) Inventors: Amer Hassan, Kirkland, WA (US); Thomas Kuehnel, Seattle, WA (US); Roy Kuntz, Kirkland, WA (US); Billy R. Anders, JR., Bothell, WA (US)

(73) Assignee: Microsoft Corporation, Redmond, WA (US)

(21) Appl. No.: 13/741,365

(22) Filed: Jan. 14, 2013

(51) Int. Cl. H04W 4/22

(52) U.S. Cl. CPC H04W 4/22
USPC 455/404.2

(57) ABSTRACT

Technologies are generally described for providing location information associated with users for emergency service purposes. User location through a wireless communication device may be determined upon triggering by a user initiated emergency communication (in various modalities) or by an external trigger signal employing one or more known signal sources and provided to an emergency service provider. The user location may also be determined/updated periodically and refined upon triggering of the emergency communication. Communication between the user's wireless device and the emergency service provider may be prioritized, in some examples, to ensure reliable communication.

### BACKGROUND

With the proliferation of computing and networking technologies, conventional communications are increasingly migrating to data networks, specifically wireless networks. For example, unified communication technologies enable users to communicate over various modalities and client devices, including portable devices, through wired and wireless networks. While cellular networks provided early wireless communication to a broad range of users, increasingly wireless local area networks, wide area networks, and similar ones are complementing or replacing the communication capabilities offered by the cellular networks. Indeed, a growing number of users are giving up their public switched telephone network (PSTN) connections in favor of voice over IP (VOIP) communication, which may utilize wireless networks including home and enterprise networks.

Emergency services are closely tied to location information of people in need of such services. Providing location information for PSTN subscribers was relatively easy since connections are static. In cellular networks, this is typically accomplished by a combination of Mobile Station Assisted (MS-A) and Mobile Station Based (MS-B) technologies that involve global positioning service (GPS) and timing triangulation methods. When it comes to communications over wireless networks such as WLANs or WANs, however, there are challenges in determining and providing location of users. For example, an IP address that is used by the device may help an emergency response center to validate the location in a coarse manner (e.g., city level) by querying the service provider who this IP address is assigned to. However, tunneling protocols used by virtual private networks (VPNs) or other communication protocols may mask the real location. Furthermore, locations of access points (APs) may not indicate a location of a user accurately, especially in multi-floor buildings and similar configurations.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing location information associated with users for emergency service purposes. User location through a wireless communication device may be determined upon triggering by a user initiated emergency communication (in various modalities) or by an external trigger signal employing one or more known signal sources and provided to an emergency service provider. In other examples, the user location may be determined/updated periodically and refined upon triggering of the emergency communication. In further examples, communication between the user's wireless device and the emergency service provider may be prioritized to ensure reliable communication.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 illustrates an example communication environment, where user location may be provided to an emergency service provider through the user's wireless communication device;

FIG. 2 illustrates an example communication environment multiple wireless networks may employ respective location servers and/or individual user devices in determining user location for emergency service;

FIG. 3 illustrates another example communication environment multiple wireless networks may employ a shared location server and/or individual user devices in determining user location for emergency service;

FIG. 4 illustrates an example of user location determination for emergency service purposes through timing of signals from multiple access points in a wireless network;

FIG. 5 illustrates another example of user location determination for emergency service purposes through signals of FM radio sources;

FIG. 6 is a networked environment, where a system according to embodiments may be implemented;

FIG. 7 is a block diagram of an example computing operating environment, where embodiments may be implemented; and

FIG. 8 illustrates a logic flow diagram for a process of determining a uses location for emergency service purposes in a wireless network environment, according to embodiments.

### DETAILED DESCRIPTION

As briefly described above, user location may be determined through a wireless communication device upon triggering by a user initiated emergency communication (in various modalities) or by an external trigger signal employing one or more known signal sources and provided to an emergency service provider.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents. While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable hardware. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es) The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

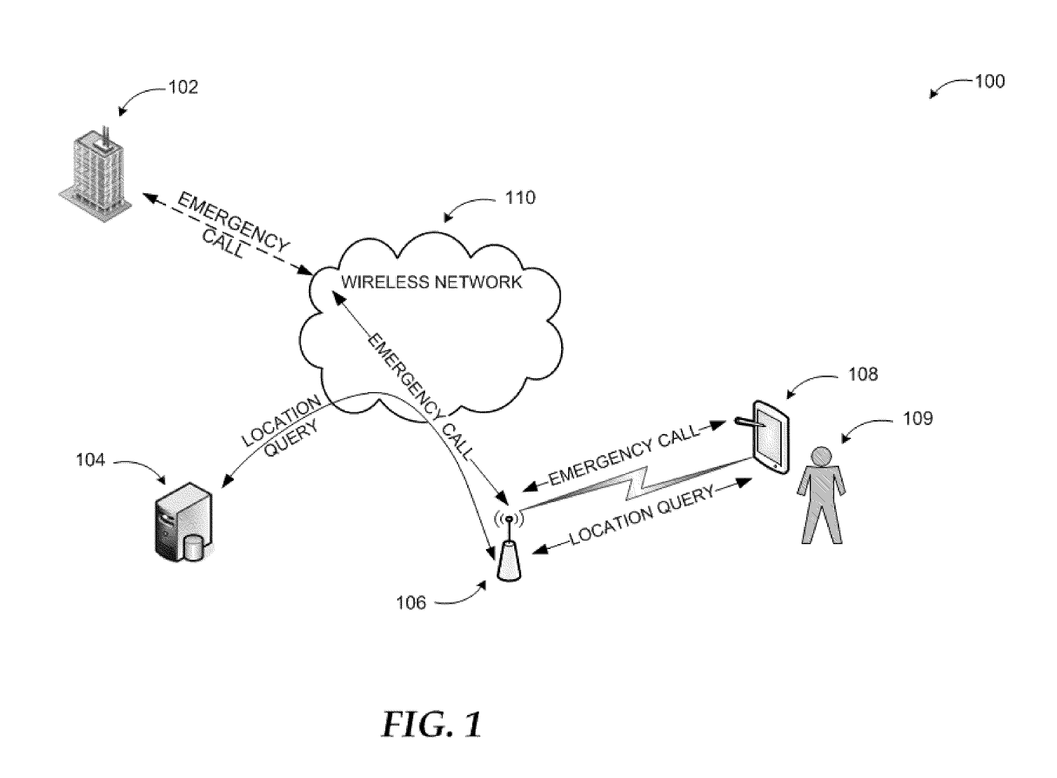

FIG. 1 illustrates an example communication environment, where user location may be provided to an emergency service provider through the user's wireless communication device.

As mentioned above, wireless networks such as WLANs and similar configurations increasingly provide multi-modal communications that replace or complement traditional PSTN or cellular calls. Users such as user 109 shown in diagram 100 may employ stationary or portable computing devices with wireless communication capability such as portable device 108 to communicate with other users on the same wireless network or on other networks (including PSTN and cellular networks). The communications may include, but are not limited to, voice call, video communications, text messaging, email exchange, data sharing, application sharing, whiteboard sharing, and comparable ones.

In a wireless network 110, portable device 108 may communicate with the network infrastructure through an access point 106. A wireless network typically includes multiple access points, and the portable device 108 may be in communication with one or more of them at any given time depending on signal quality, location, and other factors. Thus, even is the access points are stationary and their location is known, the user's location may not be accurately ascertainable when he/she is using the portable device 108 to communicate.

A system according to example embodiments may employ cognitive radio techniques, periodic triangulation, and emergency call triggered trilateration to obtain accurate positioning of a user in stress. Underlying radio technologies may use standard or proprietary wireless communications such as Wi-Fi and other radio technologies such as FM, but are not limited to those. In some embodiments, a highest possible quality of service (QoS) may be selected on the wireless and wired links once an emergency communication is triggered. To reduce the chance of the communication being interrupted or terminated, the wireless device may also switch to the most robust transmission which can be achieved by lowering its modulation rate, increasing its signal power, etc. The network and access point may do the same as soon as they detect an emergency communication is in progress.

The emergency communication may be triggered by the user 109 placing a voice call to an emergency service provider (e.g., 911), sending an emergency text message, initiating a video call to an emergency service provider 102, making a pre-established stress gesture during a video communication—which may be automatically detected by the system, and comparable actions. The emergency communication may also be triggered by external signals such as a sensor attached to the communication device (e.g., a gyroscope, an accelerometer, a thermal sensors, a pressure sensor, a radiation sensor, and comparable ones) or a signal from a monitoring entity (e.g., a service monitoring a location of the user through the portable device 108 may initiate the communication once it determines the user being outside a predefined perimeter, etc.).

In some embodiments, a location server 104 may be employed to maintain location information based on data received from the portable device 108, access point 106, and/or other devices connected to the wireless network 110. The location server 104 may determine the location of the user and provide that information in response to a location query to the portable device 108 such that the portable device can provide the information to the emergency service provider 102. In further embodiments, the portable device 108 may determine the location of the user itself and provide the information to the emergency service provider 102. The location server 104 may also employ geomapping to map the determined location to a known location.

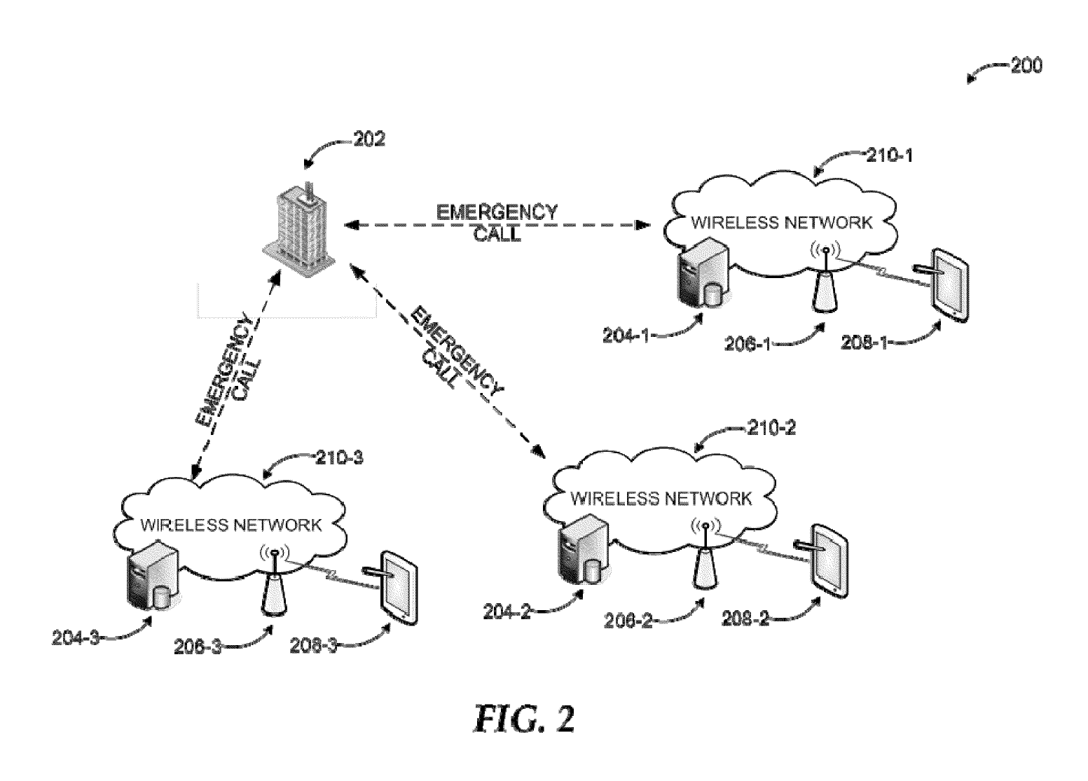

FIG. 2 illustrates an example communication environment multiple wireless networks may employ respective location servers and/or individual user devices in determining user location for emergency service.

Diagram 200, shows three example wireless networks 210-1, 210-2, and 210-3 enabling users to communicate over one or more modalities. Each of the wireless networks may have similar or distinct configurations, number of user devices, infrastructure components (servers, access points, etc.), and so on. For illustration purposes, each wireless network is shown with a representative portable device (208-1, 208-2, and 208-3) communicating with respective access points (206-1, 206-2, and 206-3). In the illustrated example configuration, each wireless network 210-1, 210-2, and 210-3 may have their own location server 204-1, 204-2, and 204-3. The respective location servers may maintain location information for the portable devices associated with the respective wireless networks and provide the information to the portable users or the emergency service provider 202.

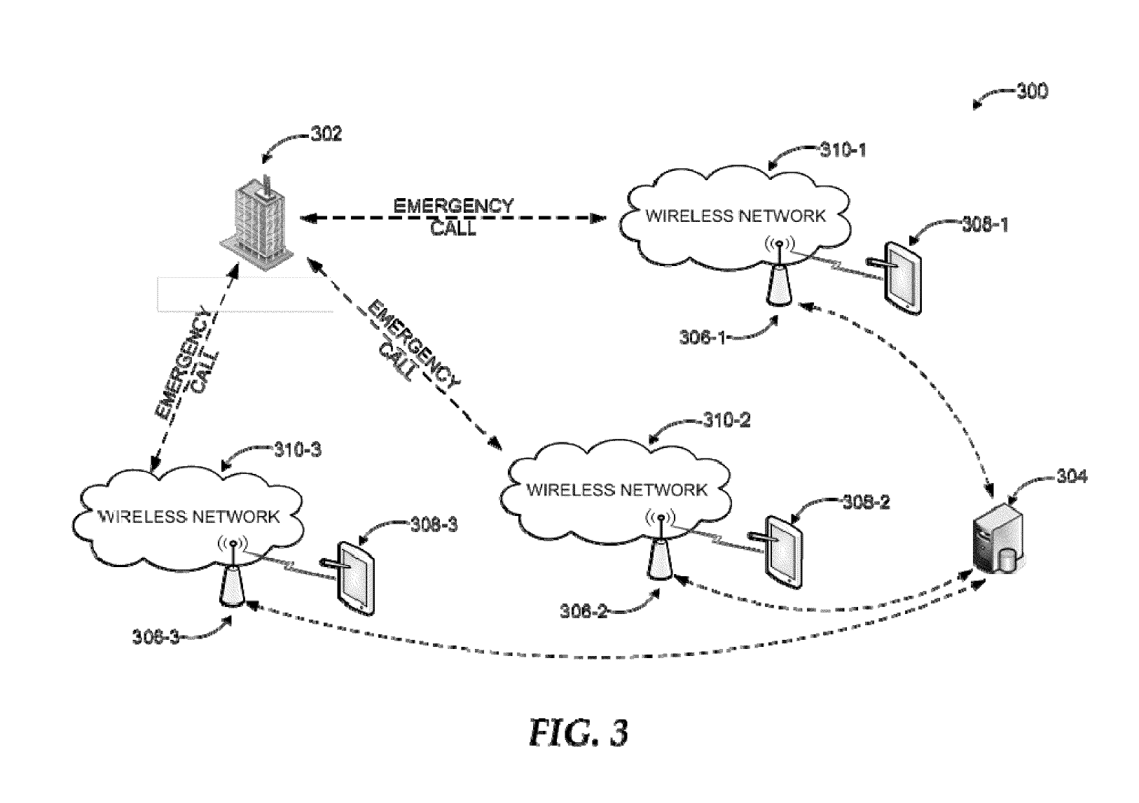

FIG. 3 illustrates another example communication environment multiple wireless networks may employ a shared location server and/or individual user devices in determining user location for emergency service.

Similar to FIG. 2, diagram 300, shows three example wireless networks 310-1, 310-2, and 310-3 enabling users to communicate over one or more modalities. Each wireless network is again shown with a representative portable device (308-1, 308-2, and 308-3) communicating with respective access points (306-1, 306-2, and 306-3). Differently from FIG. 2, however, the illustrated example configuration in diagram 300 has each wireless network 310-1, 310-2, and 310-3 sharing a common location server 304. The location server 304 may maintain location information for the portable devices associated with the wireless networks and provide the information to the portable users or the emergency service provider 302. In some examples, the location server 304 may be a separate service provided to wireless networks or part of the emergency service provider 302.

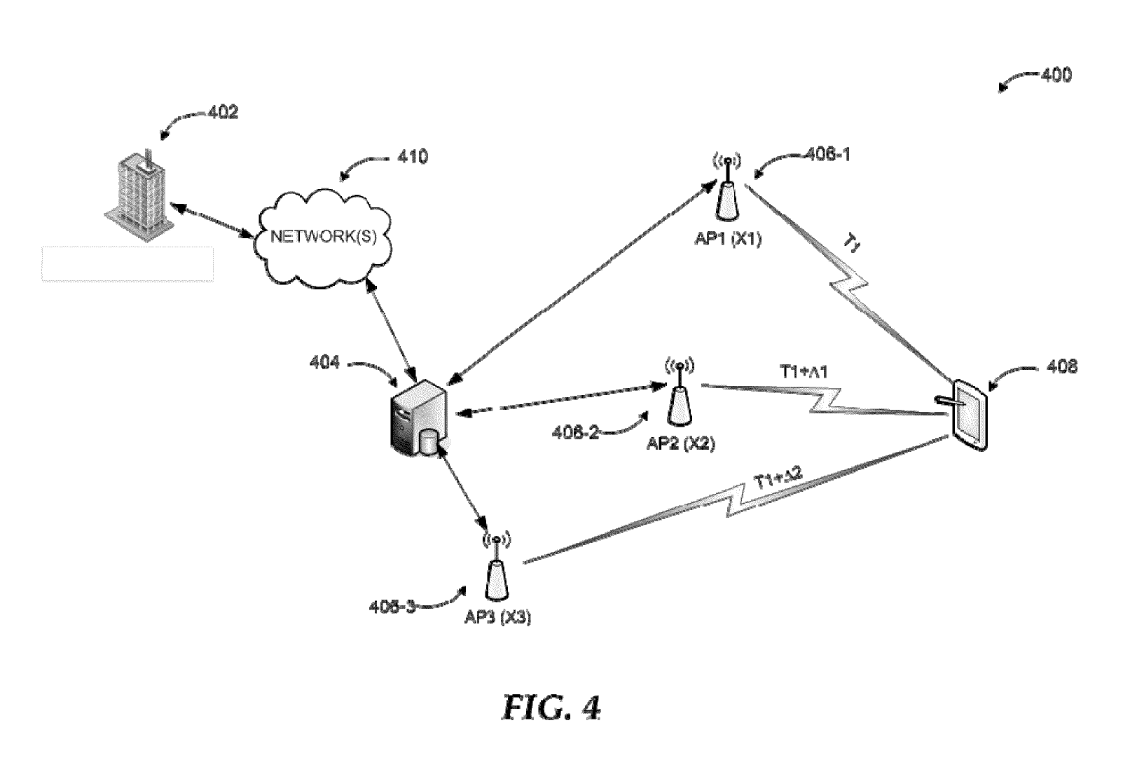

FIG. 4 illustrates an example of user location determination for emergency service purposes through timing of signals from multiple access points in a wireless network.

As discussed above, location determination for emergency services may be performed by emergency communication triggered triangulation with concurrent connections or by periodic triangulation for emergency readiness. Cognitive improvements may assist location determination further. In the user triggered option, may select a modality (1:1 or group voice call, 1:1 or group video conferencing, text messaging, application sharing, etc.) through a portable device 408. Portable device 408 may be a notebook, a tablet, a smartphone, a vehicle mount computer, a specialized communication device, and so on. The communication may be a VoIP call or comparable session.

In an example scenario, once the user initiates the emergency communication, the following sequence of events may occur. The Wi-Fi stack corresponding to the portable device 408 may list the access points in view (406-1, 406-2, and 406-3). Portable device 408 may send probes to a subset of the routers in view and the list of reliable access points may be saved. Reliable may mean access points that meet predefined criteria such as received signal strength indicator (RSSI) above a power threshold, packet error rate below a predefined threshold, number of repeats is less than a predefined threshold, etc.

Next, the portable device 408 may perform triangulation based on the access point locations (X1, X2, and X3) and timings of the access point signals (T1, T1+Δ1, and T1+Δ2). The portable device 408 may also perform assisted location improvement from location server 404 in case the access points do not have location information. In that scenario, the portable device 408 may query the location server 404 to obtain the location of the visible access points 406-1, 406-2, and 406-3. The location information may then be sent to an emergency service provider 402 over network(s) 410.

In some embodiments, the portable device 408 may perform periodic scanning of visible access points registered during a VoIP call, for example. The list may be used for periodic triangulation. In further embodiments, cognitive information, when available, may be used to further refine the location. Cognitive information may include, but is not limited to, hardware address of an access point, an office number and location, a conference room on the user's calendar, cellular triangulation, and similar ones.

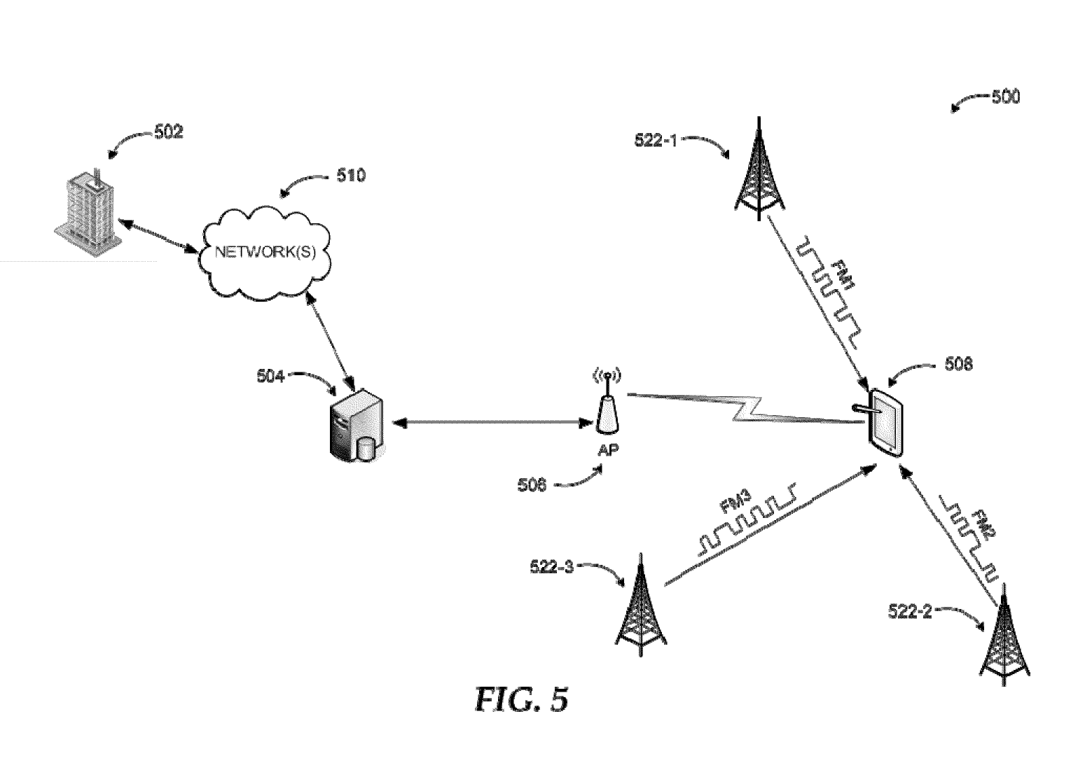

FIG. 5 illustrates another example of user location determination for emergency service purposes through signals of FM radio sources.

Diagram 500 shows a different scenario compared to diagram 400, where no location information may be available from the access points or a single access point 506 may be available to the portable device 508. A system according to embodiments may utilize any known and suitable signal source to determine the location of the portable device 508. In the example scenario of diagram 500, periodically broadcast information by FM radio stations may be used (similarly TV stations, emergency broadcast beacons, and similar sources may also be used). The periodically broadcast information may include station name, notifications, etc. Also known as RDS (Radio Data System) or RBDS (Radio Broadcast Data System), this radio station specific information from stations 522-1, 522-2, and 522-3 may be used by the portable device 508 to identify the channel and the location the radio station uniquely.

The location of the radio stations may also be resolved via the location server 504, which may include a database of the radio stations in a geographical area, like a city. Multiple radio stations that the receiver “sees” during scanning may be used for trilateration similar to the triangulation through the access points discussed in FIG. 4 and the location of the portable device 508 computed. To further increase the accuracy, the time differences of arrival of known broadcasts, station name, and the known locations of the stations transmit antennae may be used to compute the location of the device.

The above discussed configurations are example configurations for illustrative purposes. Embodiments may be implemented with other configurations and approaches using the principles described herein. For example, an emergency service beacon network may be established and used by wireless communication devices to triangulate their location. Communication modalities may include the ones discussed here or others, individually or in combination. Furthermore, emergency communications may be triggered by users, participants of an ongoing communication on behalf of a user, or other external trigger signals such as a crash detector. The processes and logic that is used to pinpoint the location of the user may be implemented at the portable device, at the location server, in the network, or at any combination of those.

In order to assure that the wireless link to the user who is in distress does not break, a highest possible QoS may be selected by the portable device for signaling and communication in some embodiments. In addition, the network infrastructure may switch to its most robust mode, which may be accomplished by lowering the modulation rate in some examples. An example scenario may be as follows. User in distress may initiate emergency communication on wirelessly connected device; direct communication link to an emergency response center may be established (signaling+voice channel); wirelessly connected device may use location sources to obtain coordinates using its sensors, radios (GPS, Wi-Fi, FM, etc.) to obtain latitude/longitude of own location; and the location may be returned to the device and sent to the emergency response center.

The location of the portable device may be reconstructed in several places such as at the portable device and then sent to the location server, at the location server saving power and providing for more sophisticated signal processing, or in the cloud with additional computational capabilities.

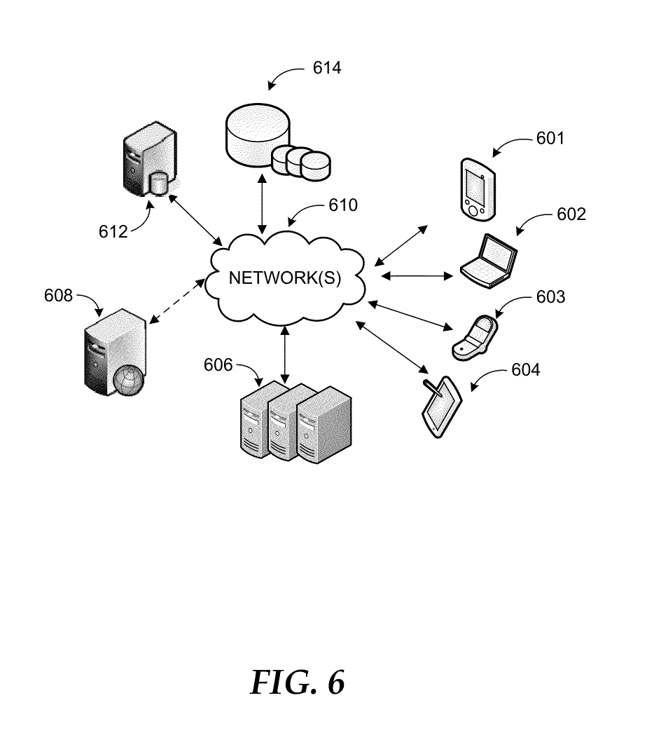

FIG. 6 is an example networked environment, where embodiments may be implemented. In addition to locally installed applications, such as communication application 722 discussed below, a communication service may also be employed in conjunction with hosted applications and services that may be implemented via software executed over one or more servers 606 or individual server 608. A hosted communication service or application may be a web-based service or application, a cloud based service or application, and similar ones, and communicate with client applications on individual computing devices such as a handheld computer 601, a laptop computer 602, a smart phone 603, or a tablet computer 604 (‘client devices’) through network(s) 610 and control a user interface presented to users. Such a service may enable users to interact with other users employing a variety of modalities and initiate emergency communications (in any one of the modalities) with location determination as discussed herein.

Client devices 601-604 are used to access the functionality provided by the hosted service or application. One or more of the servers 606 or server 608 may be used to provide location determination service as discussed above. Relevant data may be stored in one or more data stores (e.g. data store 614), which may he managed by any one of the servers 606 or by database server 612.

Network(s) 610 may comprise any topology of servers, clients, Internet service providers, and communication media. A system according to embodiments may have a static or dynamic topology. Network(s) 610 may include a secure network such as an enterprise network, an unsecure network such as a wireless open network, or the Internet. Network(s) 610 may also coordinate communication over other networks such as PSTN or cellular networks. Network(s) 610 provides communication between the nodes described herein. By way of example, and not limitation, network(s) 610 may include wireless media such as acoustic, RF, infrared and other wireless media.

Many other configurations of computing devices, applications, data sources, and data distribution systems may be employed to provide location determination for emergency services in wireless networks. Furthermore, the networked environments discussed in FIG. 6 are for illustration purposes only. Embodiments are not limited to the example applications, modules, or processes.

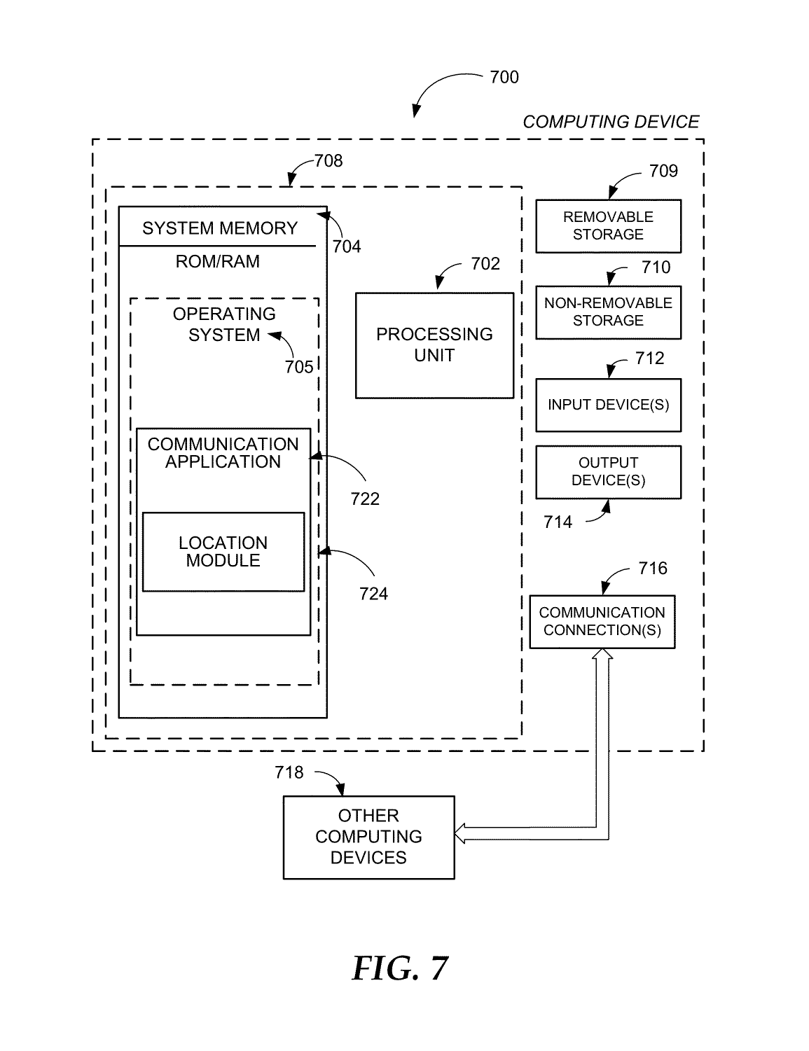

FIG. 7 and the associated discussion are intended to provide a brief, general description of a suitable computing environment in which embodiments may be implemented. With reference to FIG. 7, a block diagram of an example computing operating environment for an application according to embodiments is illustrated, such as computing device 700. In a basic configuration, computing device 700 may be any portable computing device with wireless communication capabilities, which may include touch and/or gesture detection capability in some examples, and include at least one processing unit 702 and system memory 704. Computing device 700 may also include a plurality of processing units that cooperate in executing programs. Depending on the exact configuration and type of computing device, the system memory 704 may be volatile (such as RAM), non-volatile (such as ROM, flash memory, etc.) or some combination of the two. System memory 704 typically includes an operating system 705 suitable for controlling the operation of the platform, such as the WINDOWS ®, WINDOWS MOBILE®, or WINDOWS PHONE® operating systems from MICROSOFT CORPORATION of Redmond, Wash. The system memory 704 may also include one or more software applications such as communication application 722 and location module 724.

Communication application 722 may enable communication with other devices over a wireless network through one or more modalities and also emergency communications with an emergency service provider. Location module 724 may determine location of the computing device 700 through triangulation (based on access points, radio stations, TV stations, and other sources) as well as cognitive information and provide the location information to the emergency service provider. This basic configuration is illustrated in FIG. 7 by those components within dashed line 708.

Computing device 700 may have additional features or functionality. For example, the computing device 700 may also include additional data storage devices (removable and/or non-removable) such as, for example, magnetic disks, optical disks, or tape. Such additional storage is illustrated in FIG. 7 by removable storage 709 and non-removable storage 710. Computer readable storage media may include volatile and nonvolatile, removable and non-removable media implemented in any method or technology for storage of information, such as computer readable instructions, data structures, program modules, or other data. System memory 704, removable storage 709 and non-removable storage 710 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 700. Any such computer readable storage media may be part of computing device 700. Computing device 700 may also have input device(s) 712 such as keyboard, mouse, pen, voice input device, touch input device, an optical capture device for detecting gestures, and comparable input devices. Output device(s) 714 such as a display, speakers, printer, and other types of output devices may also be included. These devices are well known in the art and need not be discussed at length here.

Computing device 700 may also contain communication connections 716 that allow the device to communicate with other devices 718, such as over a wireless network in a distributed computing environment, a satellite link, a cellular link, and comparable mechanisms. Other devices 718 may include computer device(s) that execute communication applications and comparable devices. Communication connection(s) 716 is one example of communication media, Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

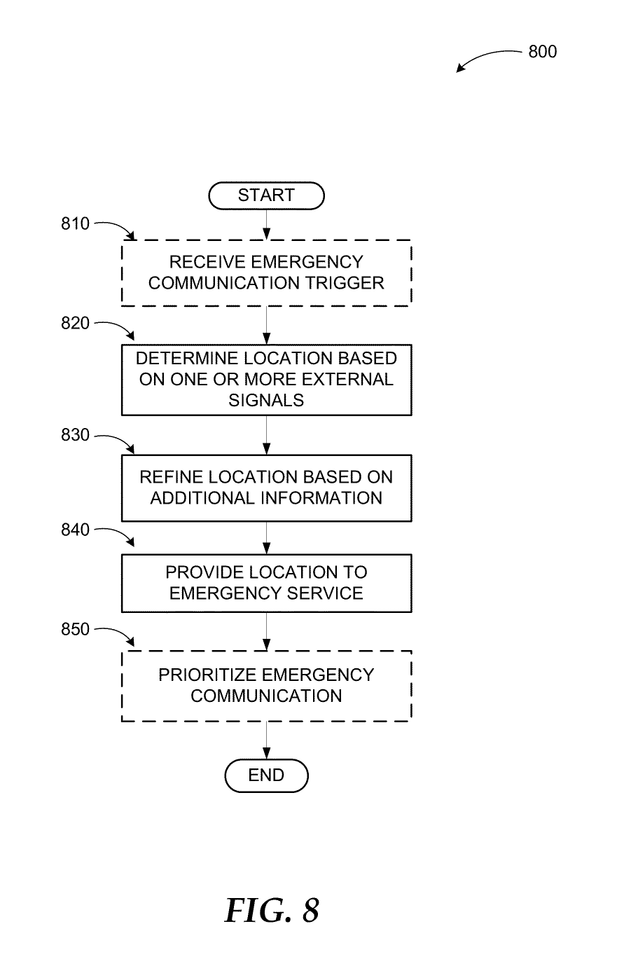

FIG. 8 illustrates a logic flow diagram for a process of determining a user location for emergency service purposes in a wireless network environment, according to embodiments. Process 800 may be implemented as part of a communication application or an emergency service.

Process 800 begins with optional operation 810, where an emergency communication trigger is received. The emergency communication trigger may be the user initiating an emergency communication or an external signal (such as one from a sensor) initiating the emergency communication automatically. Optional operation 810 may be followed by operation 820, where the location of the user's communication device may be determined based on one or more external signals such as signals from access points, radio stations, TV stations, and so on. The determination of the location may also be performed periodically (without the trigger signal) to have the communication device ready for emergency communications.

At operation 830, the location information may be further refined based on additional information such as cognitive information. Operation 830 may be followed by operation 840, where the location information may be provided to an emergency service provider. Operation 840 may be followed by optional operation 850, where the initiated emergency communication may be prioritized to ensure uninterrupted communication with the emergency service provider.

The operations included in process 800 are for illustration purposes. Location determination for emergency services in wireless networks according to embodiments be implemented by similar processes with fewer or additional steps, as well as in different order of operations using the principles described herein.

Some embodiments may be implemented in a computing device that includes a communication module, a memory device, and a processor, where the processor executes a method as described above or comparable ones in conjunction with instructions stored in the memory device. Other embodiments may be implemented as a computer readable memory device with instructions stored thereon for executing a method as described above or similar ones, Examples of memory devices as various implementations of hardware are discussed above.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for providing location information associated with users for emergency service purposes, the method comprising:
detecting initiation of an emergency communication session in a modality among one or more modalities provided by a wireless device;
determining a location of the wireless device based on a plurality of signals from wireless sources;
refining the determined location based on cognitive information; and
providing the location to an emergency service provider.

2. The method of claim 1, further comprising:
maintaining location information based on data received from the wireless device, one or more access points, and the wireless sources at a location server.

3. The method of claim 2, further comprising:
employing one of a dedicated location server for each wireless network and a shared location server for a plurality of wireless networks; and
geomapping the determined location to a known location.

4. The method of claim 1, wherein the wireless sources are access points associated with a wireless network and the method further comprises:
transmitting one or more probe signals to one or more routers in the wireless network;
determining a list of reliable access points; and
performing triangulation based on access point location and response timing information.

5. The method of claim 4, wherein the reliable access point are access points that meet predefined criteria, the predefined criteria including one or more of a received signal strength indicator (RSSI) being above a power threshold, a packet error rate being below a predefined threshold, and a number of repeats being less than a predefined threshold.

6. The method of claim 4, further comprising:
if the access point location information is not available from the access points, querying a location server associated with the wireless network for the access point location information.

7. The method of claim 1, further comprising:
employing identifying information encoded in a signal from one of a radio station, a TV station, and an emergency broadcast beacon as the plurality of signals from the wireless sources.

8. The method of claim 1, further comprising:
querying a location server for location of one of a radio station, a TV station, and an emergency broadcast beacon to be used as the wireless sources.

9. The method of claim 1, further comprising:
combining location and timing information from at least two set of access points, radio stations, TV stations, and emergency broadcast beacons to determine the location of the wireless device.

10. The method of claim 1, wherein detecting the initiation of the emergency communication session comprises one of detecting a user action through the wireless device, detecting an action by a participant of an ongoing communication session with the user on behalf of the user, and an external trigger signal.

11. The method of claim 10, wherein detecting the user action includes detecting one of: placement of a voice call to the emergency service provider, transmission of an emergency text message, initiation of a video call to the emergency service provider, a pre-established stress gesture during a video communication.

12. The method of claim 10, wherein the external trigger signal includes a signal from one or more of a gyroscopic sensor, an accelerometer, a thermal sensor, a pressure sensor, a radiation sensor attached to the wireless device, from a monitoring entity.

13. A computing device with wireless communication capability for providing location information associated with users for emergency service purposes, the computing device comprising:
a memory storing instructions;
a wireless communication module; and
a processor coupled to the memory and the communication module, the processor executing a communication application, wherein the communication application is configured to:
periodically determine a location of the computing device based on a plurality of signals from wireless sources;
detect initiation of an emergency communication session in a modality among one or more modalities provided by a computing device, wherein the emergency communication session is triggered by one of a user of the wireless device, a participant of an ongoing communication session with the user on behalf of the user, and an external trigger signal;
determine a location of the computing device based on the plurality of signals from the wireless sources following the initiation of the emergency communication session;
refine the determined location based on cognitive information;
provide the location to an emergency service provider; and
prioritize the emergency communication session to ensure uninterrupted communication between the user and the emergency service provider.

14. The computing device of claim 13, wherein the computing device is configured to communicate with one or more access points over a wireless network to facilitate communications and the one or more access points are the wireless sources.

15. The computing device of claim 13, wherein the emergency communication session is one of: a voice call, a video communication session, a text message, an email exchange, a data sharing session, an application sharing session, and a whiteboard sharing session.

16. The computing device of claim 13, wherein the location of the computing device is reconstructed at one or more of the wireless device and then sent to a location server, at the location server, and at one or more network sources.

17. The computing device of claim 13, wherein the cognitive information includes one or more of a hardware address of an access point, an office number and location, a conference room identifier on a user's calendar, and cellular triangulation.

18. The computing device of claim 13, wherein the computing device is one of: a notebook, a vehicle mount computer, a tablet, a smartphone, and a specialized communication device.

19. A computer-readable memory device with instructions stored thereon for providing location information associated with users for emergency service purposes, the instructions containing:
detecting initiation of an emergency communication session in a modality among one or more modalities provided by a wireless device, wherein the emergency communication session is triggered by one of a user of the wireless device, a participant of an ongoing communication session with the user on behalf of the user, and an external trigger signal;
determining a location of the wireless device based on a plurality of signals from wireless sources:
refining the determined location based on cognitive information;
geomapping the determined location to a known location;
providing the known location to an emergency service provider; and
prioritizing the emergency communication session to ensure uninterrupted communication between the user and the emergency service provider.

20. The computer-readable memory device of claim 9, wherein prioritizing the emergency communication session includes:
selecting a high quality of service (QoS) mode for the emergency communication session; and
one of lowering a modulation rate and increasing a signal power associated with the emergency communication session.
